(19) United States
(12) Patent Application Publication
(10) Pub. No.: US 2008/0032901 A1
(43) Pub. Date: Feb. 7, 2008

(54) Subsurface reactive sealant product

(76) Inventors: John H. Hull, Ottawa Hills, OH (US); James G. Mueller, Freeport, IL (US)

Correspondence Address: MACMILLAN SOBANSKI & TODD, LLC, ONE MARITIME PLAZA FIFTH FLOOR, 720 WATER STREET, TOLEDO, OH, 43604-1619, US

(21) Appl. No.: 11/890,769

(22) Filed: Aug. 7, 2007

Related U.S. Application Data
(60) Provisional application No. 60/835,996, filed on Aug. 7, 2006.

(51) Int. Cl. C09K 3/10

(52) U.S. Cl. 507/201; 507/200; 507/219

(57) ABSTRACT

A sealant product to form a reactive seal in a subsurface or intermittently subaqueous environment includes a reactive medium and a hydratable material that when hydrated forms the seal. For example, the reactive medium may be a zero-valent metal, a reduced metal, shredded tires, and any combinations thereof. A method of forming a reactive seal comprising applying a sealant product in a subsurface or intermittently subaqueous environment to form the seal.

### CROSS-REFERENCE TO RELATED APPLICATIONS

This application claims the benefit of U.S. Provisional Application No. 60/835,996, filed Aug. 7, 2006, the disclosure of which is incorporated herein by reference.

### BACKGROUND OF THE INVENTION

Water resources throughout the world naturally contain various concentrations of heavy metals such as arsenic, lead, chromium, etc., radionuclides, and other inorganic constituents of interest (COIs). Anthropogenic sources of inorganic and organic COIs are also widely distributed in the environment, especially throughout the industrialized world. As these water resources are developed for human or industrial use, natural barriers (e.g., aquitards) to the COI migration are often physically compromised by drilling or other intrusive construction processes. Moreover, as industrialized sites are investigated via numerous subsurface borings, these holes or voids represent new pathways for COI migration. Similarly, the installation of monitoring wells or piezometers at solid waste management sites such as landfills or wastewater treatment facilities such as lagoons may be required to provide leak detection monitoring systems. These systems are routinely monitored and the trace presence of COIs, whether naturally occurring or as a result of a detected leak, can trigger relatively significant and costly investigations.

Recognizing the potential for induced COI migration as a result of engineered structures (such as groundwater production wells, monitoring wells, subsurface well casings, caissons, pillars, pilings, dry wells, piping or utility corridors, etc.) being placed into a subsurface environment, most regulatory agencies and professional organizations have written procedures for sealing, plugging, or abandoning such subsurface structures. These procedures describe the use of various grouting agents, cements, clays, polyurethane, etc. to effectively seal the subsurface structures.

### SUMMARY OF THE INVENTION

This invention relates to a sealant product to form a reactive seal in a subsurface or intermittently subaqueous environment. The sealant product comprises a reactive medium and a hydratable material that when hydrated forms the seal.

In another embodiment, the sealant product comprises a seal-forming material and a reactive medium selected from zero-valent metals, reduced metals, shredded tires, and any combinations thereof.

The invention also relates to a method of forming a reactive seal comprising applying a sealant product in a subsurface or intermittently subaqueous environment to form the seal. The sealant product comprises a reactive medium and a hydratable material that when hydrated forms the seal.

Various aspects of the invention will become apparent to those skilled in the art from the following detailed description of the preferred embodiments.

### DETAILED DESCRIPTION OF THE PREFERRED EMBODIMENTS

The invention relates to a sealant product and a method to form a reactive seal in a subsurface or intermittently subaqueous environment. The subsurface environment can be any subsurface area which has a need for sealing, for example, an area in which construction activity, such as drilling or other intrusive construction process, and/or an engineered structure has caused a natural barrier to COI migration to be comprised. For example, the engineered structure can be any of those described above, such as groundwater production wells, monitoring wells, piezometers, subsurface well casings, caissons, pillars, pilings, dry wells, piping or utility corridors, probes, or other structures in the ground. Any type of environment can be sealed with the product, including intermittently wetted soils, subsurface aquifers, wetlands, or periodically inundated environments characterized by freshwater or saline (including brackish) conditions. The environment can be either an inundated or non-inundated environment.

The sealant product forms a seal in the environment in which it is applied. The term “seal”, as used herein, includes sealing and/or plugging any void or hole that provides a pathway for conduit for COI migration. For example, the sealant product may form a seal in a void around a targeted object such as an engineered structure, and/or the sealant product may plug a hole in the subsurface environment. In some embodiments, the seal formed by the sealant product substantially prevents cross-seal migration of organic and/or inorganic COIs.

The sealant product comprises a reactive medium and a seal-forming material. The reactive medium can be any material that is effective in reacting with, immobilizing (for example, by sequestering), treating (for example, by degrading), and/or transforming an organic and/or inorganic COI. For example, the reactive seal may be effective to sequester and/or transform a metal COI by reacting with the metal to form a metal-iron complex. It may be effective to sequester and/or transform an organic COI. It may be effective to stimulate biotransformation of an organic and/or inorganic COI. For example, in one embodiment the sealant product is effective to treat (biodegrade) organic COIs and/or immobilize (sequester) heavy metals through the formation of relatively insoluble COI-iron-sulfide complexes, which minimize the potential for COI migration. In one embodiment, the reactive nature of the sealant product is such that organic COIs that partition into the sealant will be destroyed; and inorganic COIs that tend to migrate along the preferred path of the boreholes or engineered structures are effectively sequestered. As such, use of the sealant product can prevent contamination of environments.

Any suitable material or a combination of different materials can be used as the reactive medium. For example, some materials that can be used as the reactive medium include zero-valent metals, reduced metals, shredded tires, catalysts, activated carbon, organic carbon, and any combinations thereof. The reactive medium can be in any form, such as powdered, granular, or pelletized form. The relative quantities of the reactive medium and other components in the sealant product will depend upon specific project needs and goals.

The seal-forming material of the sealant product can be any material, or a combination of different materials, effective to form the seals as described above. For example, some materials that may be useful as the seal-forming material include clays, clay-sized materials, bulking agents, sand, sand-sized materials, aggregate, and binding agents, either alone or in combinations. In one embodiment, the seal-forming material is a hydratable material that when hydrated forms the seal, for example, by swelling to fill the void or hole.

The sealant product may have a variety of general physical configurations. In one embodiment, the sealant product is in the form of composite particles which act as a delivery vector for the hydratable material and the reactive material. In a particular embodiment, the composite particles are manufactured composite particles of the type sold as the AquaBlok® composite particle system by AquaBlok, Ltd., Toledo, Ohio. The AquaBlok® composite particle system is described in the following patents, all of which are incorporated by reference herein: U.S. Pat. No. 5,538,787 issued Jul. 23, 1996; U.S. Pat. No. 5,897,946 issued Apr. 27, 1999; U.S. Pat. No. 6,386,796 issued May 14, 2002; and U.S. 6,558,081 issued May 6, 2003. In one embodiment, each composite particle comprises a relatively dense core and a sealant layer at least partially encapsulating the core, the sealant layer being capable of absorbing water and swelling to form an effective seal. The sealant layer is made from a hydratable seal-forming material. The reactive medium of the sealant product is usually incorporated into the sealant layer of the composite particle, although in some embodiments it could also be incorporated into the core.

In more detail, a plurality of the AquaBlok® composite particles form an effective seal. In one embodiment, a seal formed with the particles has a low water permeability so that it is resistant to leakage of water and dissolved contaminants. For example, in one embodiment the seal has a water permeability of less than 1×10⁻⁷ cm/sec. under a minimum hydraulic gradient of 1 cm/cm according to ASTM Method D 5084.

Each of the AquaBlok® composite particles includes a core which is at least partially encapsulated by a sealant layer. The core is preferably completely encapsulated by the sealant layer. In one embodiment, a protective coating is provided over the sealant layer.

The core of the composite particle is usually formed of a piece of a material which is relatively dense and may be relatively hard when compared to the sealant layer. For example, the core may be dense so that it acts as a carrier of the composite particle to the area to be sealed. Examples of suitable materials for forming the core include pieces of rock or stone, iron ore, slag, glass cullet, crushed glass or crushed porcelain. For some specific project applications, a less dense core (e.g., perlite) relative to the sealant layer may be used. In some embodiments, the specific gravity of the composite particle, as a whole, is greater than one.

In another embodiment, the core of the composite particle is formed of a degradable material so that it can slowly dissipate over a period of time. Various materials can be used to form a degradable core. For example, some degradable materials include sand, small stones or rocks, rubber tire chips, sugar-based materials such as rock candy, pelletized recycled paper such as magazines or newspapers, pelletized clay mineral that hydrates very slowly, or high-density fertilizer. These materials can be held together by a binder, such as those used in the sealant layer, to create any size core needed. The core of the composite particle can also be formed of pozzolanic materials such as gypsum, gypsum fines, portland cement, cement kiln dust, lime dust, stone dust, fly ash, and plaster of Paris. These materials will be described in more detail below.

The core of the composite particle is at least partially encapsulated by a sealant layer. The material in the sealant layer forms the seal. A preferred type of material for the sealant layer is a clay mineral, or a mixture of clay minerals, which exhibits a high absorption and swelling capacity upon hydration. Preferably a dry clay mineral is used in the sealant layer. Any type of clay mineral can be used, such as bentonite, attapulgite and/or kaolinite. A clay-sized material can also be used, such as gypsum, having an average particle size of less than about 10 microns. The sealant layer may also contain other clay or quasi-clay sized materials such as organophylic bentonite (“organo clays”), zeolites, inorganic oxides of aluminum, iron, and/or manganese, and/or humic substances.

A pozzolanic material can be used in the sealant layer to create a hardened seal. The term “pozzolanic material” means a material that is capable of setting and hardening under water. Suitable pozzolanic materials include gypsum, gypsum fines, portland cement, cement kiln dust, lime dust, stone dust, fly ash, and plaster of Paris.

Optionally, the sealant layer can also include a binder. The binder promotes the adhesion of the sealant layer to the core. Any suitable binder can be used, for example, a polymeric material, such as a cellulosic polymer. Other suitable binders include glues, lignites (sap), starch grafted polyacrylates, and soybean oil lecithins and their derivatives.

The composite particle may be provided with an outer coating, such as a thin polymeric coating about the sealant layer. Some examples of suitable polymers include acrylic resins and latexes. The outer coating is thin enough so that it does not prevent hydration of the sealant layer.

The principle and mode of operation of this invention have been described in relation to its preferred embodiments. However, it must be understood that this invention may be practiced otherwise than as specifically described without departing from its scope.

What is claimed is:

1. A sealant product to form a reactive seal in a subsurface or intermittently subaqueous environment, the sealant product comprising a reactive medium and a hydratable material that when hydrated forms the seal.

2. A sealant product according to claim 1 wherein the seal formed by the sealant product substantially prevents cross-seal migration of organic and/or inorganic constituents of interest.

3. A sealant product according to claim 1 wherein the sealant product is in the form of composite particles which act as a delivery vector for the hydratable material and the reactive material.

4. A sealant product according to claim 1 wherein the sealant product is used to form a subsurface seal around a targeted engineered structure.

5. A sealant product according to claim 4 wherein the engineered structure is a casing, caisson, pillar or piping.

6. A sealant product according to claim 1 wherein the seal formed by the sealant product is used to plug a hole.

7. A sealant product according to claim 1 wherein the reactive seal is effective to sequester and/or transform a metal constituent of interest by reacting with the metal to form a metal-iron complex.

8. A sealant product according to claim 1 wherein the reactive seal is effective to sequester and/or transform an organic constituent of interest.

9. A sealant product according to claim 1 wherein the reactive seal is effective to stimulate biotransformation of an organic and/or inorganic constituent of interest.

10. A sealant product to form a reactive seal in a subsurface environment comprising a seal-forming material and a reactive medium selected from zero-valent metals, reduced metals, shredded tires, and any combinations thereof.

11. A sealant product according to claim 10 wherein the reactive seal is effective to sequester and/or transform a metal constituent of interest by reacting with the metal to form a metal-iron complex.

12. A sealant product according to claim 10 wherein the reactive seal is effective to sequester and/or transform an organic constituent of interest.

13. A sealant product according to claim 10 wherein the reactive seal is effective to stimulate biotransformation of an organic and/or inorganic constituent of interest.

14. A method of forming a reactive seal comprising applying a sealant product in a subsurface or intermittently subaqueous environment to form the seal, the sealant product comprising a reactive medium and a hydratable material that when hydrated forms the seal.

15. A method according to claim 14 wherein the seal formed by the sealant product substantially prevents cross-seal migration of organic and/or inorganic constituents of interest.

16. A method according to claim 14 wherein the sealant product is in the form of composite particles which act as a delivery vector for the hydratable material and the reactive material.

17. A method according to claim 14 wherein the sealant product is used to form a subsurface seal around a targeted engineered structure.

18. A method according to claim 14 wherein the seal formed by the sealant product is used to plug a hole.

19. A method according to claim 14 wherein the reactive seal is effective to sequester and/or transform a metal constituent of interest by reacting with the metal to form a metal-iron complex.

20. A method according to claim 14 wherein the reactive seal is effective to sequester and/or transform an organic constituent of interest.

21. A method according to claim 14 wherein the reactive seal is effective to stimulate biotransformation of an organic and/or inorganic constituent of interest.

22. A method according to claim 14 wherein the reactive medium is selected from zero-valent metals, reduced metals, shredded tires, and any combinations thereof.
